(19) United States
(12) Patent Application Publication
(10) Pub. No.: US 2009/0183599 A1
(43) Pub. Date: Jul. 23, 2009

(54) MINERAL EXTRACTION SYSTEM AND PROCESS

(75) Inventors: Aaron Bruce Mawby, North Fremantle (AU); Clinton John Giraudo, North Fremantle (AU); Nicholas Geoffrey DeVere, North Fremantle (AU)

Correspondence Address: BROOKS KUSHMAN P.C., 1000 TOWN CENTER, TWENTY-SECOND FLOOR, SOUTHFIELD, MI, 48075, US

(73) Assignee: DEVERE MINING TECHNOLOGIES LIMITED, North Fremantle, WA (AU)

(21) Appl. No.: 12/282,970

(22) PCT Filed: Mar. 16, 2007
(86) PCT No.: PCT/AU2007/000320

§ 371 Date: Feb. 12, 2009

(30) Foreign Application Priority Data
Mar. 16, 2006 (AU) 2006901357

(51) Int. Cl. B22F 9/20; B03B 5/00

(52) U.S. Cl. 75/370; 266/114

(57) ABSTRACT

A trench leaching system including a tank containing a charge of ore flooded with a liquid solvent up to the level of a gutter. A pump recirculates the solvent upwardly through the charge of ore via a sparging array for dissolving minerals which are reclaimed through a series of cyclones and stripped out of the pregnant solvent by a carbon column. The rate and pressure of the solvent flowing through the sparging array upwardly though the of ore are kept below the amount that would fluidise the ore and at an amount that produces channels which follow random paths that vary with time through the ore, wherein particles of ore in the channels are agitated by the solvent and wherein particles of ore outside the channels are maintained substantially static and in contact with the liquid solvent. Such a system can process low grade ore at low operating and capital costs.

### FIELD OF THE INVENTION

The present invention relates to the extraction of minerals from a charge of ore using a lined trough in which a mineral extraction process is undertaken.

More particularly, the present invention relates to a system and process for the extraction of minerals from a charge of ore placed in a trough, using leaching techniques, substantially at atmospheric pressure and temperature.

### BACKGROUND TO THE INVENTION

A number of valuable metals (e.g. gold, copper, nickel, tungsten) are held in very small quantities (e.g. typically from 1 to 100 ppm) in large ore bodies. To extract these minerals, the ore must be crushed and sometimes ground, to allow a liquid chemical solvent (e.g. sulphuric acid, hydrochloric acid, sodium cyanide) to dissolve the valuable minerals, or to allow bacteria to access the valuable minerals. The dissolved minerals drain out from the ore carrying the valuable minerals. The solution can be further processed to remove the valuable minerals. This entire extraction process is called leaching.

There are three main leaching processes for carrying out mineral extraction, namely heap leaching, tank leaching and vat leaching.

### Heap Leaching

Heap leaching typically involves the formation of layers of crushed mineral bearing ore into a pile or heap set upon an impermeable pad. A leaching agent is sprayed onto the heap and percolates through the heap, dissolving some of the valuable mineral. The leaching agent with dissolved mineral is collected by drainage underneath the heap and recirculated to the top of the heap to perform further leaching. Typically, the heap leaching processing time is between about 90 days and a year.

More specifically, heap leaching involves coarsely crushing the ore (to around 12 mm maximum particle size) and stacking the crushed ore on a plastic liner covered with crushed granite and drainage pipes. The plastic liner is typically laid on contoured near-level ground and the crushed ore (“heap”) is piled generally 10 to 30 metres above ground. On top of the heap is placed a reticulation system for distributing a liquid solvent onto the heap. The liquid solvent is sprayed onto the heap and allowed to leach through the ore body. It may take up to 12 months to maximise yields to about 70%.

The problems of heap leaching include:
Varying concentrations of mineral ore resulting in over and under utilisation of liquid solvent, resulting in inefficient use of liquid solvent, unprocessed ore and excessive operating costs.
Restricted flow of liquid solvent due to compaction and silting up.
The retention of the mineral-containing chemical in the crushed ore body, resulting in lower yields.
Chemical spillage, leakage, dust creation, and dilution by rainwater.
The tendency of liquid solvent to flow in fixed channels (referred to as “rivering”), thus bypassing the unprocessed ore.
Solar loading, which can greatly increase the operating temperature of the excavated heap, seriously reducing the effectiveness of the leaching operation.

A serious problem associated with some heap leach installations is that they can fail to release any of their valuable minerals. According to the leading operators of heap leach installations, there is no way to overcome such failed heap leaches. In particular, to date there has been no reprocessing that can economically yield profits from a failed heap leach.

### Tank Leaching

It is known to extract minerals from a body of ore by excavating the ore, crushing and grinding it to particles below a predetermined size, introducing the ground ore into a reaction chamber and then stirring the chamber. This is referred to as “tank leaching”.

The physical processes of tank leaching involve both crushing and grinding of the ore to less than around 100 μm particle size. The ground ore is placed in large tanks, where the liquid solvent is added. The mixture is stirred and heated (if required). Typically, about 9 hours is required for the leaching process and a total of 24 hours for associated draining and flushing processes. Typically, yields of 85% to 95% of the minerals contained in the ore are achievable.

The main problem of tank leaching is the high cost of construction and operation of the process, with significantly higher costs per tonne when compared to heap leaching. The high cost and compact nature of the tank leaching system minimises the ability to economically process large quantities of low-grade ore.

### Vat Leaching

Vat leaching is similar to heap leaching except that the heap is smaller, located in a vat and immersed in liquid solvent so as to soak the ore to extract the minerals. This process typically takes 9 to 20 days and yields between 65% and 85%—depending upon particle size and residency times.

The main limitation of vat leaching is that particle sizes must be maintained relatively large, i.e. −6 mm, so that the liquid solvent can drain downwardly through the body of ore.

There are a large number of mineral bearing ore bodies that cannot be economically processed by any of these three prior art leaching techniques. There is a clear need for a leaching system that has low energy input, low minerals handling component and can accommodate materials smaller than 2 mm in particle size, and more preferably less than 0.5 mm, and able to tolerate ultra-fine particles down to around 1 μm.

The present invention was developed with a view to providing a mineral extraction system and process that has at least some of the advantages of heap, tank and vat leaching techniques, whilst overcoming many of their inherent disadvantages.

References to prior art in this specification are provided for illustrative purposes only and are not to be taken as an admission that such prior art is part of the common general knowledge in Australia or elsewhere.

### SUMMARY OF THE INVENTION

According to one aspect of the present invention, there is provided a liquid injecting means for a leaching system for extracting valuable minerals from a charge of particularised ore by the use of a liquid solvent, the liquid injecting means including an arrangement of liquid carrying pathways locatable below the charge of ore, and a plurality of downwardly facing apertures distributed about the pathways for producing a plurality of channels of upwardly flowing liquid solvent through the charge of ore, the channels following random paths that vary with time through the charge of ore, wherein particles of ore in the channels are agitated by the liquid solvent, the remaining particles of ore being substantially static and wherein the liquid carrying pathways are devoid of upwardly facing apertures and delivering the liquid solvent at a rate and pressure below that required to cause stratification of the charge of ore.

According to another aspect of the present invention there is provided a trench leaching system for extracting valuable minerals from particularised ore, the system comprising:

a delivery means for delivering a charge of the particularised ore;
a tank capable of receiving and retaining the charge of particularised ore for leaching with a liquid solvent;
a liquid injecting means located beneath the charge of ore in the tank for producing a plurality of channels of upwardly flowing liquid solvent through the charge of ore, the liquid injecting means being operated at a flow rate and pressure less than is required to cause fluidisation of the charge of ore, the channels following random paths that vary with time through the charge of ore, and wherein particles of ore in the channels are agitated by the liquid solvent, the remaining particles of ore being substantially static;
a liquid recirculation means for collecting the liquid solvent from on top of the charge of ore and returning it to the injecting means; and,
a liquid collecting means for collecting at least some of the liquid solvent for stripping out dissolved minerals.

Preferably, said liquid injecting means is in the form of a sparging means located contiguous a floor of the tank. Typically said, sparging means comprises an array of sparging pipes comprising a plurality of branch lines supplied by main lines, each of the sparging pipes having a plurality of holes provided therein for injecting the liquid solvent into the slurry of particularised ore. Preferably, said holes in the sparging pipes are arranged in a non-upwardly facing direction so as to avoid ingress of ore particles. Preferably, said holes are disposed in a downwardly facing direction at an angle exceeding about 45 degrees to the horizontal.

Typically, the liquid injecting means also comprises a pump for pumping liquid solvent through the holes in the sparging array into the charge of particularised ore. Preferably, the pump is adapted to deliver sufficient flow and pressure of liquid solvent to create a flow rate of between 1 to 5 cm/s of liquid solvent through the charge of ore via the holes.

Preferably, the tank also has a liquid solvent overflow located below an upper edge of the tank. Typically, the liquid solvent overflow is in the form of a gutter, the base of which slopes downwardly. Preferably, an upper surface of the charge of ore is located below the liquid solvent overflow, with a layer of liquid solvent on top of the charge of ore. Preferably, the tank is supplied with liquid solvent up to the level of the liquid solvent overflow.

Where dissolved gases are required in the leaching process, it is preferred that a gas sparging means be provided in the circuit. A gas sparger may be provided in the liquid solvent above the charge of ore for maintaining the concentration of dissolved gas at a level sufficient to facilitate a mineral extraction process.

In accordance with yet another aspect of the present invention, there is provided a process for extraction of valuable minerals from a charge of particularised ore, the process including the steps of:

locating a liquid injection means below the charge of ore;
maintaining the charge of ore substantially static above the liquid injection means; and,
injecting liquid solvent upwardly through the charge of ore at a rate and pressure capable of producing a plurality of channels flowing upwards through the charge of ore, the channels following random paths that vary with time through the charge of ore, wherein particles of ore in the channels are agitated by the liquid solvent and wherein particles of ore outside the channels are maintained substantially static and in contact with the liquid solvent.

In accordance with yet another aspect of the present invention, there is provided a process for extraction of valuable minerals from particularised ore the process including the steps of:

introducing a charge of particularised ore into a tank;
maintaining the charge of ore substantially static in the tank; and,
injecting liquid solvent upwardly through the charge of ore at a rate and pressure capable of producing a plurality of channels flowing upwards through the charge of ore, the rate and pressure being less than required to cause stratification of the said ore, and the channels following random paths that vary with time through the charge of ore, wherein particles of ore in the channels are agitated by the liquid solvent and wherein particles of ore outside the channels are maintained substantially static and in contact with the liquid solvent;
recirculating the liquid solvent by draining some of the liquid solvent from on top of the charge of ore and returning it beneath the charge of ore to be pumped upwardly again through the charge of ore; and,
collecting some of the liquid solvent for stripping out dissolved minerals.

Preferably, said step of injecting liquid solvent through the charge of ore comprises pumping liquid solvent through the particularised ore at a sufficient flow and pressure to create a flow rate of between 1 to 5 cm/s of liquid solvent through the charge of ore. Typically, the remainder of the charge of ore is substantially static and in contact with the liquid solvent.

Preferably, the process comprises the further steps of removing fines entrained in the liquid solvent and returning the liquid to the tank via the pump and the sparging array. The fines are preferably returned to an upper region of the tank. Preferably, the process also comprises the step of removing ultrafine particles from the liquid solvent after it is collected for stripping out dissolved minerals.

Hereinafter, the mineral extraction system and process of the present invention will be referred to as a “Trench Leaching System”. The Trench Leaching System will be described with particular reference to the leaching of gold, but it can also be used with other minerals, including copper, nickel, platinum, tungsten and the like, which can be leached under atmospheric pressure and substantially atmospheric temperature.

The Trench Leaching System has the advantage that it processes ore on a large scale, with low capital cost, using minimal handling of the ore and is considerably more cost effective than conventional mineral extraction processes. Thus, the Trench Leaching System has most of the advantages of heap leaching, tank leaching and vat leaching, but without many of their inherent disadvantages.

The operation of the Trench Leaching System relies upon the random movement of the liquid solvent in relatively narrow channels upwards through a charge of ore placed in a trench. These channels are somewhat similar to those of heap leaching—except that in heap leaching the liquid solvent tends to flow downwardly in “rivers” that are fixed in their route through the ore. In the Trench Leaching System, the ore within the random channels of upwardly flowing liquid solvent is subject to agitation, which liberates the valuable mineral in a manner similar to that of tank leaching, without the mechanical stirrers and associated energy requirements. This random channelling of the liquid solvent produces a migration of the liquid solvent through substantially the entire charge of ore, resulting in agitation of substantially all of the ore particles, thus giving a yield similar to that of tank leaching. The remainder of the charge of ore is static and in contact with the liquid solvent in much the same manner as vat leaching, which has the advantage of starting to dissolve the valuable mineral in preparation for agitation by the random channelling, which is not achieved by vat leaching.

Throughout the specification, unless the context requires otherwise, the word “comprise” or variations such as “comprises” or “comprising”, will be understood to imply the inclusion of a stated integer or group of integers but not the exclusion of any other integer or group of integers. Likewise the word “preferably” or variations such as “preferred”, will be understood to imply that a stated integer or group of integers is desirable but not essential to the working of the invention.

### BRIEF DESCRIPTION OF THE DRAWINGS

The nature of the invention will be better understood from the following detailed description of several specific embodiments of the Trench Leaching System, given by way of example only, with reference to the accompanying drawings, in which:

FIG. 1 is a partially cut-away perspective view, shown from above, of a preferred embodiment of the Trench Leaching System in accordance with the present invention;

FIG. 1a is a partially cut-away perspective view, shown from above, of another preferred embodiment of the Trench Leaching System in accordance with the present invention;

FIG. 2 is a schematic side view of a crushing circuit, leaching circuit and recovery circuit of the Trench Leaching System of FIG. 1;

FIG. 3 is a perspective view, shown from above, of a portion of a sparging system of the Trench Leaching System of FIG. 1;

FIGS. 4a to 4d are a series of sketches depicting a typical sequence of changes of the channelling of liquid solvent as it flows upwardly through a charge of ore in a tank of the Trench Leaching System of FIG. 1; the changes are over a period of hours;

FIG. 5 is a perspective view seen from above of a test cell for the Trench Leaching System of the present invention; and,

FIGS. 6 and 7 are partially cut-away perspective views seen from above of two sparging assemblies of the test cell of FIG. 5.

### DETAILED DESCRIPTION OF PREFERRED EMBODIMENTS

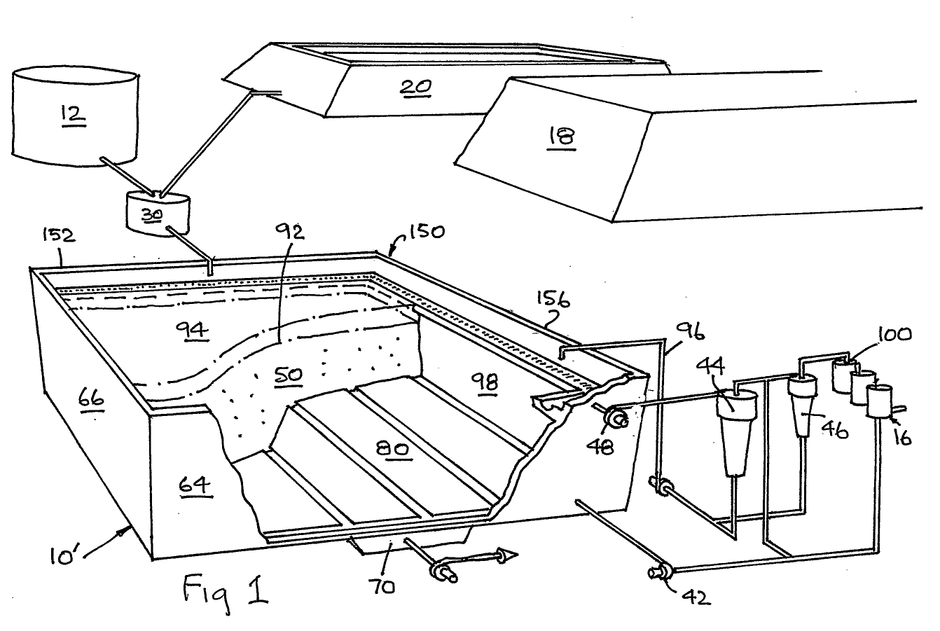

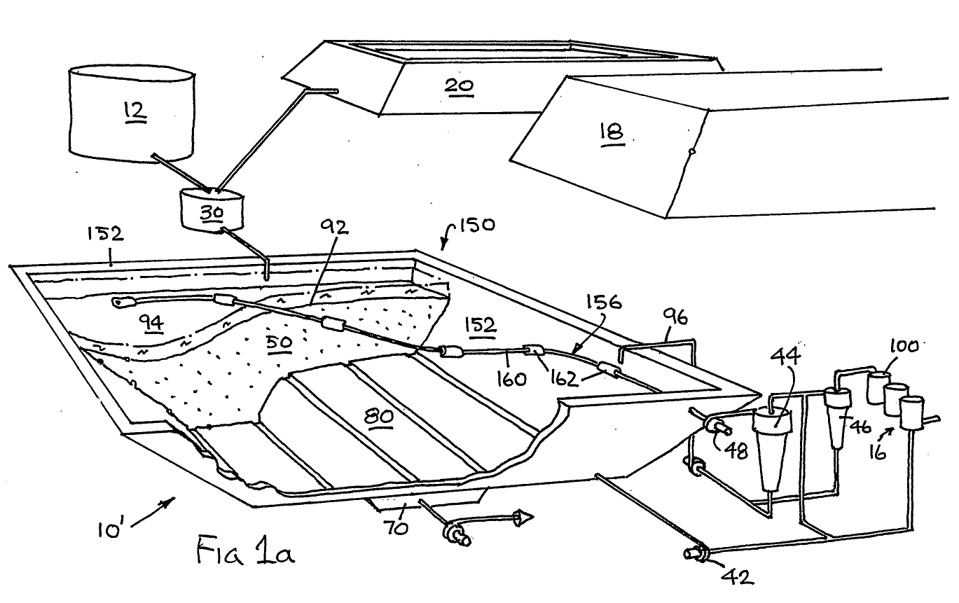

In FIGS. 1 and 2 there is shown an exemplary embodiment of the Trench Leaching System 10 in accordance with the present invention. The Trench Leaching System 10 includes a crushing circuit 12, a leaching circuit 14, a stripping circuit 16, a waste circuit 18 and a water reservoir 20.

The crushing circuit 12 is typically of conventional form and is designed to provide ore outputs with particle sizes of <500 μm. It is envisaged that other ore size outputs could be used, depending upon the fractioning of the precious mineral in the ore. The output of the crushing circuit 12 has a pulp density control system 30 for delivering the crushed ore in a slurry form to the leaching circuit 14.

It is also envisaged that in reprocessing of tailings dumps, no crushing circuit will be required.

It is also envisaged that the ore could be introduced to the leaching circuit in a dry form.

The leaching circuit 14 includes a processing tank 40, a sparging pump 42, a main wet cyclone 44, a secondary bleeder cyclone 46 and a slurry pump 48.

The output of the pulp density control system 30 is plumbed into the upper reaches of the processing tank 40. A charge of ore 50 is, in this embodiment, formed in the processing tank 40 in a slurry form.

The processing tank 40 is typically substantially rectangular when viewed in plan and cross section. The processing tank 40 has a sloping floor 60 and four upwardly disposed walls including end walls 62 and 64, and sidewalls 66 and 68.

Typically, the floor 60 has a slope of about 2 degrees to the horizontal from the end 62 towards the end 64 to assist in the removal of the charge of ore 50 once the leaching processes are considered complete. “Complete” in the context of the leaching process, is an economic determination of the cost of recovering more valuable mineral balanced against its sale value. When there is insufficient profit, the leaching process is halted. The floor 60 has a sump 70 located adjacent the end wall 64 for emptying of the processing tank 40.

It is to be understood that the floor 60 could have other orientations and could be shaped differently. For example, the floor 60 could be flat, alternatively the floor 60 could be V-shaped in its transverse direction; that is, sloping inwardly from both side walls 66 and 68, delivering into a central gutter to assist draining of the charge of ore 50 from the tank 40. Alternatively, the floor 60 could have an inverted V-shape delivering into two gutters at the lower extent of the floor 60.

In the exemplary embodiment, the processing tank 40 is about 20 metres in length, 10 metres wide and 3 metres high. However, it is to be understood that other dimensions can also be used and the tank 40 does not have to be rectangular in shape. Conveniently, the walls 62 to 68 are formed from a cementitious material such as concrete or the like. However, it is envisaged that the walls 62 to 68 could be formed of metal materials so as to render the processing tank portable. For this purpose, it is considered that the width and length may be reduced slightly to comply with motor vehicle transport laws and regulations. It is also envisaged that the processing tank 40 could be provided with a cover (not shown) to inhibit the ingress of rain and detritus materials and to inhibit the egress of water vapour.

It is envisaged that the tank 40 could be formed from dirt that is stabilised and lined with an impermeable layer.

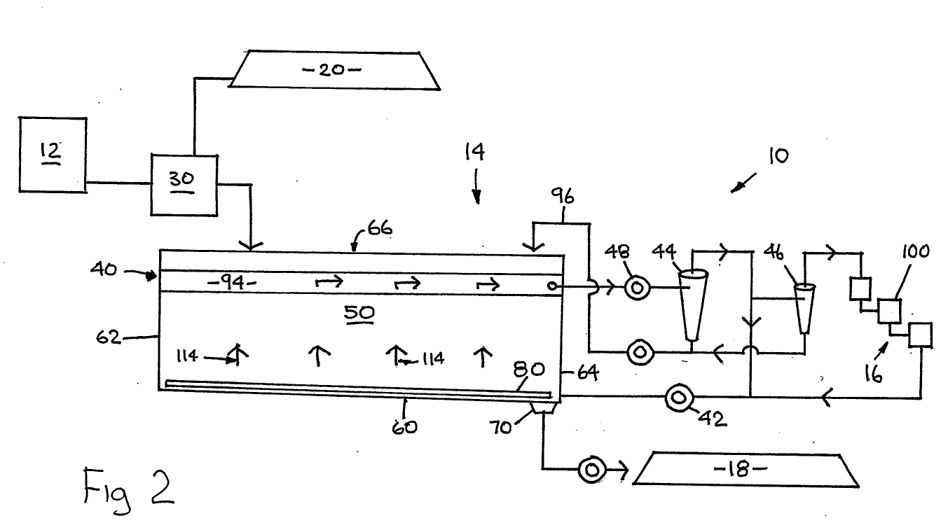

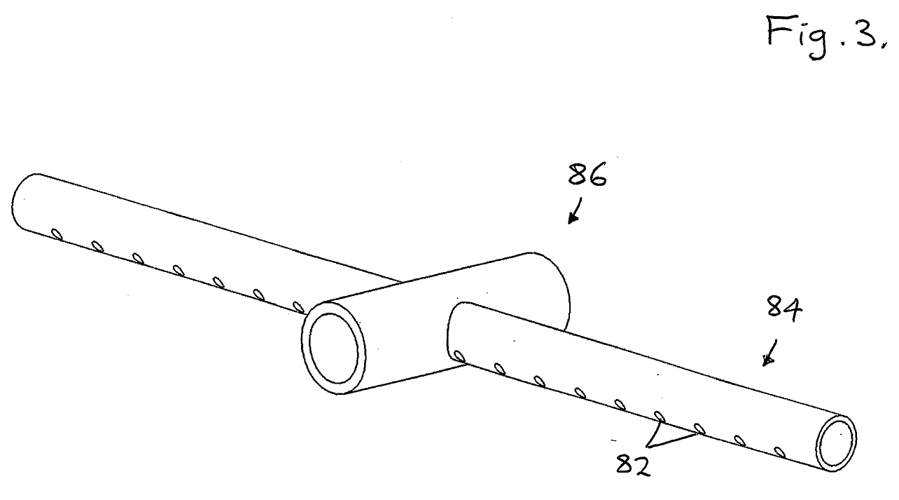

The processing tank 40 also includes a liquid injecting means in the form of sparging array 80 of sparging pipes located contiguous the sloping floor 60. The sparging array 80 has a multitude of holes 82 (see FIG. 3) arranged for directing a flow of liquid solvent (leachant) upwardly through the processing tank 40. In the exemplary embodiment the sparging array 80 has about 72,000 holes 82 located upon a plurality of branch lines 84 supplied by main lines 86. It is highly desirable that each of the holes 82 throughout the sparging array 80 receives the same flow and pressure of the liquid solvent. For this purpose, it is envisaged that the branch lines 84 could be tapered in cross section away from the main line 86.

It is preferred that the holes 82 be arranged in a non-upwardly facing direction so as to avoid ingress of ore particles. Preferably, the holes 82 are disposed in a downwardly facing direction at an angle exceeding about 45 degrees to the horizontal.

For ore particle sizes of <500 μm, it is envisaged that the holes 82 have a diameter of about 2 mm so as to inhibit blockage thereof. Typically the holes 82 are located on 35 mm spacings and the branch lines 84 are located on 50 mm spacings. It is to be understood that other hole sizes and spacings, and branch line spacings could be used.

The pump 42 is designed to deliver enough flow and pressure of liquid solvent to create a flow rate of about 1 cm/s of liquid solvent through the charge of ore 50 via the holes 82. This flow rate is relatively low and is not sufficient to lift the charge of ore or to cause it to stratify. The flow rate is only sufficient to create narrow channels of liquid solvent flowing upwardly through the charge of ore 50. These channels are not fixed in their direction and orientation, but rather follow random paths through the ore 50. Nevertheless, the flow of liquid solvent from the holes 82 is sufficient to agitate particles of the ore 50, which has the effect of liberating the precious mineral in a manner similar to that of tank leaching, without the need for mechanical stirrers or the associated energy requirements. These random channels of the liquid solvent migrate, over a period of many hours, through the entire charge of ore 50, agitating substantially all of the ore particles, thus giving a yield similar to that of tank leaching. The remainder of the charge of ore is substantially static and in contact with the liquid solvent.

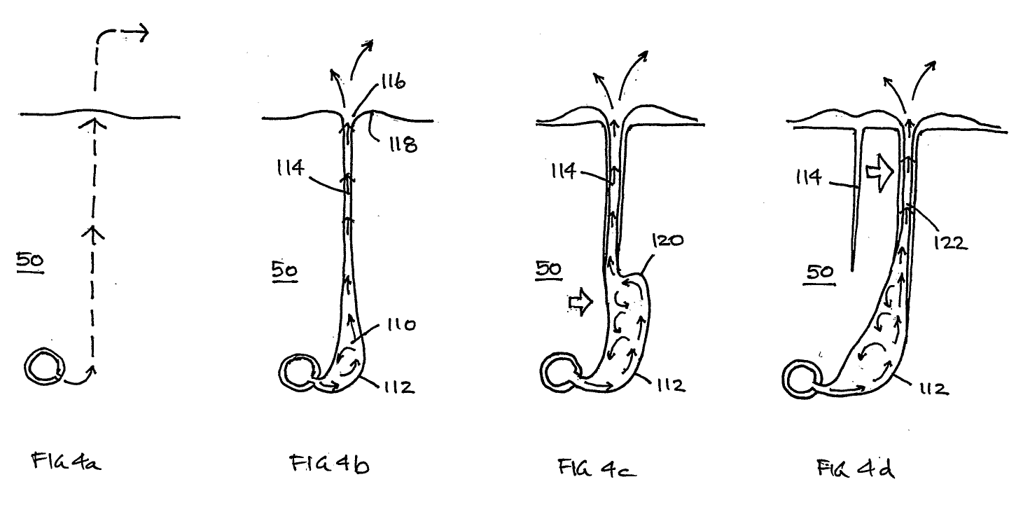

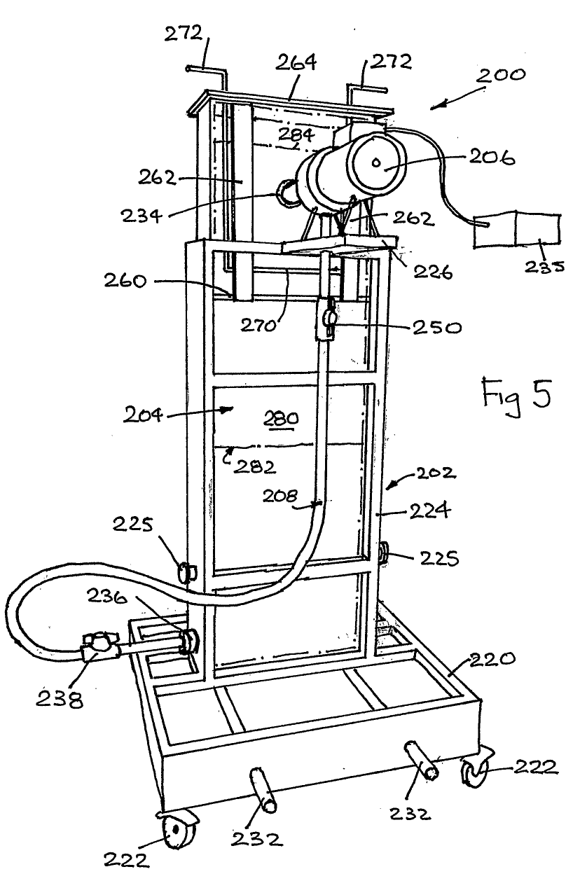

The process of formation and random migration of the channels is depicted in FIGS. 4a to 4d and is described in more detail below.

The processing tank 40 also has a liquid solvent overflow 90 located about 0.5 metres below the upper reaches of the walls 62 to 68. Conveniently, the liquid solvent overflow 90 is in the form of a gutter, the base of which slopes downwardly towards the pump 48. An upper surface 92 of the charge of ore 50 is located about 0.5 metres below the liquid solvent overflow 90 with a layer 94 of about 0.5 metres of liquid solvent on top of the charge of ore 50.

It is envisaged that the overflow 90 could be replaced with an array of pipes located in the liquid solvent above the charge of ore 50.

Preferably, the processing tank 40 is supplied with liquid solvent up to the level of the liquid solvent overflow 90. In the case of leaching a gold bearing ore, the liquid solvent typically has a concentration of about 0.01% cyanide.

In the leaching of gold ore, it is preferred that an air sparger be provided in the liquid solvent above the charge of ore 50 for maintaining the concentration of dissolved oxygen at a level sufficient to maintain a good cyanidation process. It is considered that a concentration of dissolved oxygen of greater than about 5 ppm is desirable. More preferably, a concentration of dissolved oxygen of greater than 7 ppm is maintained.

The tank 40 is provided with a liner 98 arranged to inhibit leakage of the liquid solvent through the tank 40 in the event that it is made from liquid pervious materials.

The outlets 92 and 94 are connected to the cyclone 44 for the removal of fines entrained in the leachate and to return the liquid to the processing tank 40 via the pump 42 and the sparging array 80. The fines are returned from the cyclone 44 via a slurry pump 48 and a slurry return line 96 to the upper regions of the processing tank 40.

The leaching cell is also provided with an aeration device for injecting a relatively low concentration of air or oxygen into the liquid solvent. This can be conveniently achieved via a sparging array located in the liquid solvent above the charge of ore 50. Alternatively, the air injection device could be a pump, a venturi or source of compressed air or the like.

The secondary bleeder cyclone 46 is plumbed to the liquid outlet of the main cyclone 44 and provided to remove ultrafine particles from the leachate before it is sent to the stripping circuit 16. The fines from the bleeder cyclone 46 are returned to the slurry pump 48.

The stripping circuit 16 is typically in the form of a conventional set of carbon columns 100 known for stripping the dissolved gold from the pregnant liquor (leachate). The barren liquor is returned to the sparging pump 42. Once fully impregnated, the carbon lattices are removed from the carbon columns 100 and sent for further processing to produce gold bullion.

The Trench Leaching System 10 is typically installed at a location in close proximity to a mine site where the ore is being excavated to be leached of its mineral content.

Typically, the tank 40, when made from concrete, is constructed in the well known tilt slab manner. The slabs are tilted substantially vertically and their corners joined to form the tank 50. Typically, the walls 62 to 68 are disposed at an angle of about 5 degrees to the vertical, outwardly from the confines of the tank 50. The amount of flaring of the tank is limited by the channelling process and it is considered that, in the present embodiment, the walls should not flare out more than 15 degrees.

Ore containing precious mineral is mined and taken to the crushing circuit 12. The ore is crushed in a multi-stage crushing plant to a particle size, which, in the exemplary embodiment, is less than about 500 μm.

Prior to charging the tank 40 with crushed ore, the tank 40 is filled with water and/or liquid solvent. This is desired so as to reduce abrasion of the walls 62 to 68 and the sparging array 80 as the ore is dumped into the tank 40.

The crushed ore is delivered to the pulp density control system 30 then conveyed to the tank 40. The ore slurry sinks through the liquid solvent to the floor 60 and spreads outwardly. The ore slurry continues to fill the tank 40 until its upper level is about 0.5 metres below the drain-line 90. This signifies completion of the formation of the charge of ore 50 in the tank 40 and leaching processes can be commenced. In this condition, there is about 0.5 metres of liquid solvent above the charge of ore 50.

During the filling of the tank 14 with the ore 50, liquid solvent is slowly pumped through the sparging array 80 so as to inhibit the ingress of the ore 50 into the sparging array 80.

The sparging array 80 is also provided with a purging facility in the form of a drain or outlet, oriented so as to allow the liquid solvent to flow out of the array 80 without having to flow through the ore 50. In this way, any ore 50 or detritus material lodged in the array 80 can be removed and returned to the upper reaches of the tank 14 to rejoin the ore 50 and be processed, rather than being lost from the system 10.

The sparging pump 42 is now activated to deliver a continuous stream of the liquid solvent collected from on top of the charge of ore 50 to the sparging array 80. The liquid solvent exits the sparging array 80 through the 72,000 holes 82 and flows upwardly through the charge of ore 50, which is already saturated with liquid solvent. The flow of liquid solvent delivered from the sparging pump 42 therefore generates a region of relatively high pressure upstream of each of the holes 82. The liquid solvent then continues to flow in an upward direction, following the path of lowest resistance until it reaches the upper surface of the charge of ore 50, which is covered with a layer of liquid solvent maintained at atmospheric pressure.

A typical flow path of liquid solvent through the charge of ore 50 is shown in FIG. 4a. As time continues, the flow of liquid solvent from any given hole 82 starts to create localised erosion of the charge of ore 50, indicated at 110 in FIG. 4b. The erosion 110 creates a cavity 112, which has a high concentration of liquid and a low concentration of particles of ore 50. This imbalance in concentration allows the upward flow of liquid solvent to generate turbulence, which has the effect of agitating the particles and hence maximising the leaching of precious minerals there from. The energy of the upwards flow of liquid solvent has the effect of lifting some of the ore particles to the top of the charge of ore 50 through a channel 114 and deposits them around an opening 116 in a mound 118. During the passage of time of a number of hours, the turbulence typically forms an undercut 120 in the channel 114, as shown in FIG. 4c. Simultaneously, finer ore particles are deposited on the inside of the channel 114 and on the mound 118. As the undercut 120 continues to grow, the mass of ore particles proximate thereto becomes unstable and collapses, which truncates the channel 114 and commences a new channel 122, as shown in FIG. 4d. The new channel 122 is displaced laterally from the original channel 114, which has the effect of causing the channels of liquid solvent to migrate through the charge of ore 50 in a random manner. Over a period of many hours, the random movement of all of the channels 114 within the charge of ore 50, has the effect of turbulently leaching substantially all of the ore particles in the tank 40.

Via this process, the liquid solvent travels upward through the charge of ore 50 in less than 4 minutes, more particularly, between about 1 and 4 minutes, for example, about 2½ minutes. The time taken is a factor of the ore particle size, the properties of the ore, the depth of the charge of ore 50, and the flow pressure and characteristics of the sparging pump 42.

The sparging pump 42 can be operated in low and high flow rate modes. The low flow rate mode delivers a low flow rate to the charge of ore 50 for maintaining agitation of the ore particles 50 in the channels 114, with the remainder of the particles substantially static but in contact with the liquid solvent. In the high flow rate mode, the channels 114 are disrupted to form the new channels 122. The high flow rate mode is particularly useful in conditions where the low flow rate tends to lead to the ore settling out and the channels 114 collapsing but not forming new channels 122. This has been found to be more likely to happen in re-processing gold tailings where the particle size is 100% passing 80 microns or less.

In practice, the high flow rate may be used for between 1 to 5 minutes to establish new channels 122 and the low flow rate used for between 30 minutes to several hours, so long as the channels 114 are maintained and continue to migrate around the charge of ore 50.

The liquid solvent is continually recycled through the charge of ore 50 via this process. From time to time, a portion of the pregnant leachate is drawn off via the cyclones 44 and 46 and stripped of valuable mineral by the carbon filters 100. The barren leachate is returned to the sparging array 80 via the sparging pump 42.

Periodically the ore in the tank 40 is assayed to determine the amount of recovery of minerals. Once the yield has reached a satisfactory level, the tank 40 can be drained of liquid solvent through the sump 70. Then the charge of ore 50 is flushed with water or chemicals to prepare the ore for disposal as tailings in the waste circuit 18.

Once the residual ore is safe, it is pumped out of the sump 70 to the waste circuit 18 and the water reclaimed there from and returned to the water reservoir 20.

An air injection device is used to aerate the liquid solvent.

It is envisaged that a number of tanks 40 could be placed in a battery arrangement and plumbed to the cyclones 44 and 46 and the sparging pump 42 in a shared configuration. The tanks 40 could be operated substantially independently of each other in a batch type operation whereby each tank 40 has ore at different stages of the leaching process.

Also, it is envisaged that, where the ore could be introduced into the tank 40 in a dry form, the tank 40 is not initially charged with the liquid solvent. In this case, the charge of ore 50 is made relatively level in the tank 40 and the liquid solvent is introduced via the sparging array 80 to flood the ore 50 from the bottom up. In this situation, the liquid solvent could also be introduced into the ore 50 from above.

Further, the concrete tank 14 could be replaced with a trench 150, see FIG. 1a, of similar size dug in the ground with sloping walls 152 and lined with a plastics material liner 154 capable of inhibiting the egress of the liquid solvent 94. The trench leaching system 10′ as it applies to the trench 150 is substantially the same as for the concrete tank 14. In the trench leaching system 10′, the gutter 90 is replaced with a floating skimmer 156. The floating skimmer 156 is formed from a pipe 160 with floats 162 located periodically along its length to inhibit it from sinking under the force of the weight of the liquid solvent and any entrained particles of the ore 50. Also, the pumps 42 and 48 are plumbed into the trench 150 over the walls 152 and not through them. Further, the walls 152 of the trench 150 slope at around 45 degrees to the vertical, so as to substantially avoid the possibility of subsidence.

The trench 150 can be installed upon a tailings heap and the tailings re-processed in-situ without the need of producing a new tailings heap.

### Test Cell

The effectiveness of the Trench Leaching System for gold extraction was tested using a 75 kg sample of ore. The results and performance were compared to those achieved by traditional Bottle Roll Cyanidation technology to simulate the recovery possible from a stirred tank reactor.

The test was conducted in a test cell 200 as illustrated in FIGS. 5 to 7, being in the form of an open top cell comprising a frame 202, an ore casing 204, a pump 206 and plumbing 208. The frame 202 has a base 220 conveniently provided with wheels 222 to allow movement of the test cell 200. The frame 202 also has a casing support frame 224 disposed upwardly from the base 220 for supporting the ore casing 204. The casing support frame 224 is provided with lugs 225 disposed to allow inversion of the test cell 200. The frame 202 also has a mounting frame 226 located proximate the upper regions of the frame 202 for supporting the pump 206.

The ore casing 204 is rectangular in plan and elevation with internal dimensions of 500 mm width, depth 100 mm and height 2.5 metres. The ore casing 204 has two outlet ports 230 located at its lower end and connected to drain pipes 232. The ore casing 204 also has an inlet port 234 located about 400 mm beneath its top. The inlet port 234 feeds the pump 206 for delivery of liquid to the plumbing 208. The pump 206 is connected to a source of electrical power via a controller 235. Typically the electrical power is 240 volts AC and the controller 235 adjusts the proportion of the power delivered to the pump 206 via frequency modulation between 0 and 50 Hz. In the test cell, the power delivered to the pump 206 was about 350 W and was typically operated at about 12.5 Hz. It is to be understood that much lower frequencies of operation yield insufficient energy input to the charge of ore 50, which results in ineffective channelling of the liquid solvent. More particularly, tests have shown that with certain ore, frequencies below 7 Hz are not useful.

The ore casing 204 is provided with a removable sparging tube 236 sealed into its lower reaches. The sparging tube 236 is disposed longitudinally through the width of the casing 204. Typically, it has fourteen holes 237 disposed to produce a flow of liquid upwardly through the casing 204. Preferably the holes are disposed downwardly and outwardly and have a diameter of about 2 mm. The sparging tube 236 is provided with a valve 238 for interrupting the flow of liquid there through. The valve 238 is connected to the pump 206 via the plumbing 208. The plumbing 208 includes a valve 250 for controlling the flow of liquid from the pump 206 to the sparging tube 236.

The ore casing 204 further includes a removable screen 260 located below the inlet port 234. The screen 260 is provided with a mesh 261 having an aperture size typically less than 250 μm and more preferably less than 70 μm. The screen 260 is sealed to the inner surface of the walls of the casing 204. The screen 260 also has four supports 262 disposed upwardly and fixed to the top of the casing 204. Conveniently, the supports 262 are bolted to the casing 204. The casing 204 has a lid 264 for sealing off its top to inhibit evaporation of contained liquid. Typically the lid 264 has a seal and can be bolted onto the casing 204 to provide a liquid-tight barrier to inhibit leakage of the liquid when the test cell 200 is inverted.

An air sparging tube 270 is located within the space between the mesh 261 of the screen 260 and the inlet port 234 for delivering a relatively low flow of air into the liquid contained in the casing 204. The sparging tube 270 has air delivery tubes 272, which exit the casing 204 via the lid 264. The air sparging tube 270 is suspended within the liquid via the air delivery tubes 272. The air sparging tube 270 has holes 274 preferably located on its underside. Conveniently, the air sparging tube 270 is provided with three holes 274, each with a diameter of about 1 mm.

Testing using the test cell 200 was conducted as follows:

### 1. METHODOLOGY

### 1.1 Sample Preparation

A 75 kg sample of gold oxide ore was prepared in the following manner:
Oven dried a 75 kg batch of oxide ore at 60° C.
Crushed and screen material to 100% passing 0.5 mm
Blended the 75 kg of −0.5 mm material and split out 5 kg head sample
Split out 3×100 g samples and sent for head assay
   The head sample assay produced the gold mineralization analysis of Table 1.

TABLE 1
Head sample gold analyses results

| SAMPLE | Au ppm |
|---|---|
| 1 | 1.18 |
| 2 | 1.27 |
| 3 | 1.23 |
| Average | 1.23 |

### 1.2 Test Work Parameters

The test work parameters were:
Residue Mass: 50 kg
Solution Volume: 68.5 l
pH: >9.5 maintained with sodium hydroxide addition
Cyanide Concentration: >0.01%
Treatment Period: 199 hours
Variable Speed Device: 12.5 Hz

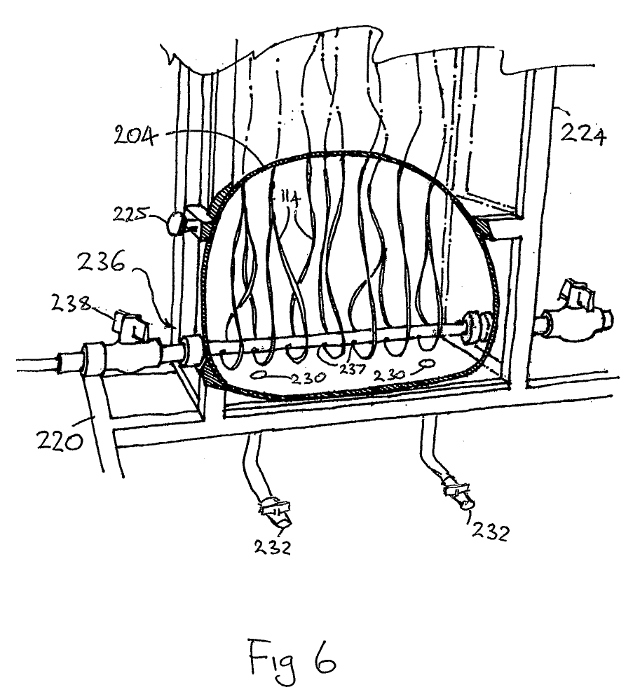

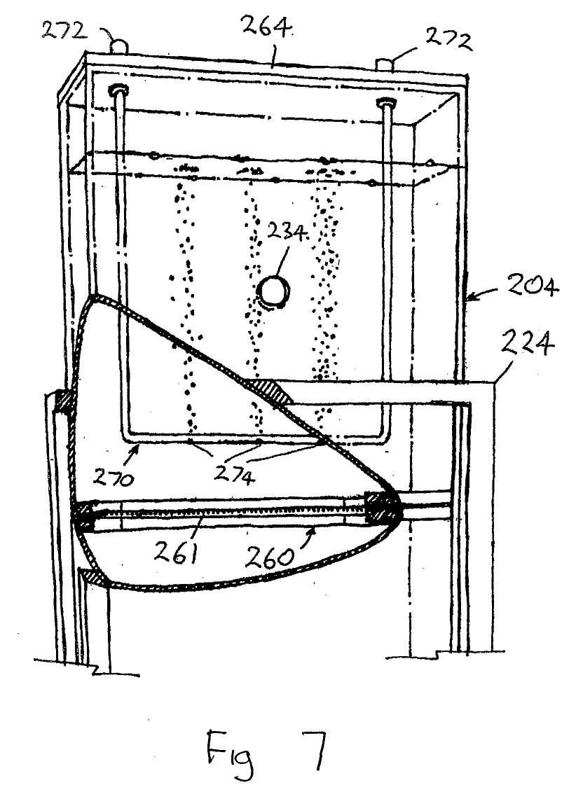

Approximately 50 litres of water were introduced into the ore casing 240 and 50 kg of the test sample were metered into the water so as to minimize splashing and to form a charge of ore 280. An upper surface 282 of the charge of ore 280 was located about 800 mm above the base 220. The remainder of the water was then added to the ore casing 240 up to 68.5 litres with an upper surface 284 located about 50 mm below the lid 264. The pump 206 was activated to draw liquid in through the inlet port 234 and delivered it via the valves 250 and 238 to the sparging tube 236. The liquid exited holes 274 in the sparging tube 236 in a downward and outward direction and flowed upwardly through the charge of ore 280 in a series of channels 114, as described herein above (see FIG. 6). The flow of liquid in the channels caused fine ore particles to be lifted above, the top of the charge of ore 280 towards the pump 206. The screen 260 inhibited the motion of particles greater than about 70 μm from rising to the upper reaches of the ore casing 204. Some of the finer particles were drawn in by the inlet port 234 but were found not to cause undue sedimentation in the plumbing 208 and the sparging tubes 236 and 270.

Sodium Hydroxide was added to the liquid to achieve a pH of >9.5 and maintained at this level for the entire test period. Once the pH was stabilized, Sodium Cyanide was added to the liquid in a concentration of >0.01%.

Throughout the majority of the test period, the pump controller 235 was operated at a frequency of about 12.5 Hz. However, after 120 hours of leaching, the controller 235 was operated at 50 Hz for a period of 30 seconds every 24 hours, so as to flush sediments from the sparging tube 236.

The solution was sampled on a regular basis over the test period of 199 hours; pH and cyanide concentration were monitored and adjusted in order to maintain the required test work parameters. The trial was terminated by draining the solution and water washing the residue. The residue was then removed from the cell and sampled, the representative sample was oven dried at 60° C. and screened to 100% passing 850 μm, sampled and assayed for gold content. Gold dissolution was calculated based on residue analyses; these are presented in Table 2.

TABLE 2
Residue sample gold analyses results

| SAMPLE | Au ppm |
|---|---|
| 1 | 0.095 |
| 2 | 0.090 |
| 3 | 0.090 |
| Average | 0.092 |

### 1.3 Bottle Roll Leach Testwork

Duplicate bottle roll cyanidations were conducted on the ore sample. The tests were conducted in 4.5 litre plastic rolling bottles at the following testwork parameters:
Residue Mass: 500 g
% Solids: 50
pH: >9.5 maintained by adding sodium hydroxide
Cyanide Concentration: >0.01%
Treatment Period: 24 hours

The solutions were monitored on a regular basis to ensure that the pH was maintained above pH 9 and the cyanide concentration was around 0.1%. The tests were terminated by filtration, the filtrate collected and assayed for gold. The residues were water washed and oven dried at 60° C. and screened at 850 μm and assayed for gold. The gold recoveries were calculated based on the residue analyses.

### 2. RESULTS AND DISCUSSION

### 2.1 Test Cell Cyanidation Testwork

The operation of the test cell 200 was an alternative to conventional cyanidation leach techniques for gold dissolution.

Gold dissolution achieved with the test cell 200 was calculated to be 91% after a 199-hour leaching period. Records indicate that the maximum dissolution was achieved within 144 hours. Dissolved oxygen was measured at 55 and 127 hours respectively, the average dissolved oxygen in solution being 7.8 ppm, providing ample oxygen for gold dissolution to take place and indicating that the air sparging array 270 is required.

Cyanide consumptions for the test work were calculated to be 0.18 kg/t, which is very economical and around 25% of the consumption of the comparative bottle-roll test.

Sodium Hydroxide consumptions for the test work were calculated to be 0.22 kg/t, which is very economical.

### 2.2 Bottle Roll Cyanidation Testwork

Duplicate bottle roll cyanidation of the ore sample resulted in gold dissolutions of 90% and 87%, respectively.

Cyanide consumptions for the bottle roll test work were calculated to be 0.76 kg/t, which is considered economical.

Sodium Hydroxide consumptions for the bottle roll test work were calculated to be 0.12 kg/t, which is very economical.

### 2.3 Comparison

Gold dissolution following cyanide leaching in the test cell 200 was 91%, which was well within the results obtained by bottle roll cyanidation. The gold dissolution achieved using the test cell 200 is comparative to that achievable in a stirred tank (as simulated by a bottle roll cyanidation) and the leach period, being 199 hours, was considerably less than could be expected by conventional heap leach, and still competitive with known vat leach scenarios.

The gold dissolution presented in Table 3 compares the results of the duplicate bottle roll cyanidations on the sample ore to those achieved by the test cell 200.

TABLE 3
Cyanidation Test Work

| | | Test Cell | | | | | |
|---|---|---|---|---|---|---|---|
| | | | | Cyanidation Residue | | | |
| | | Head | | | | Rela- | % Au |
| Sample | Sample | Mass | Au | Mass | Au | tive | Disso- |
| Name | Descriptn. | kg | ppm | Kg | ppm | Mass | lutn. |
| Test | 100% | 50.00 | 1.23 | 49.12 | 0.092 | 0.98 | 91 |
| Cell | Passing | | | | | | |
| 199 hrs | 0.5 mm | | | | | | |
| Bottle | 100% | 0.500 | 1.23 | 0.4977 | 0.12 | 0.99 | 90 |
| Roll | Passing | | | | | | |
| Fraction | Test 1 | | | | | | |
| 24 | 100% | 0.500 | 1.23 | 0.4979 | 0.15 | 0.99 | 87 |
| hrs | Passing | | | | | | |
| | Test 2 | | | | | | |

It is to be noted that maximum dissolution for the test cell 200 was achieved at 144 hours.

### 2.4 Sizing & Gold Content

A representative head sample from the sample pre-cyanide leach was sized into 3 fractions, being −75 μm, 75 to 250 μm and +250 μm. The gold content of each size fraction is presented in Table 4.

TABLE 4
% Mass & Gold Content by Size Fraction of the Head Sample

| Size Fraction | % by Mass | Gold (ppm) |
|---|---|---|
| +250 μm | 26.84 | 1.11 |
| 75 to 250 μm | 22.97 | 0.73 |
| −75 μm | 50.19 | 1.05 |
| Overall (calculated) | 100.00 | 0.96 |

The +250 μm fraction had the highest gold concentration (1.11 ppm). The average gold content of the representative head sample of Fraction E was 0.96 ppm.

A representative tail sample from Fraction E post-cyanide leach was sized into 3 fractions, being +250 μm, 75 to 250 μm and −75 μm. Each size fraction was analysed for gold content and the results are presented in Table 5.

TABLE 5
% Mass & Gold Content by Size Fraction of Tail Sample

| Size Fraction (mm) | % by Mass | Gold (ppm) |
|---|---|---|
| +250 μm | 24.61 | 0.28 |
| 75 to 250 μm | 23.76 | 0.115 |
| −75 μm | 51.63 | 0.11 |
| Overall (calculated) | 100.00 | 0.17 |

The +250 μm fraction had the highest gold concentration (0.28 ppm). The average gold content of the representative tail sample of Fraction E was 0.17 ppm; this means that there was approximately 82% recovery based on the two samples used. The ratio of recovery is as follows:
75% recovery from the +250 μm material
84% recovery from the 75 to 250 μm material
90% recovery from the −75 μm material

### 3. CONCLUSIONS

The test cell 200 had a gold yield equivalent to that representative of a conventional tank leach, with approximately one quarter the consumption of cyanide and about double the consumption of sodium hydroxide. This indicates that the mineral leaching system of the present convention is equally efficient as conventional tank leaching in the extraction of gold, with lower operating costs and less consumables.

Now that preferred embodiments of the Trench Leaching System have been described in detail, it will be apparent that it provides a number of advantages over the prior art, including the following:
(i) Tank leaching systems require substantially more crushing, grinding and processing energy and hence are more expensive than the present invention, with little or no difference in yield.
(ii) The capital costs of the leaching plant for the tank leaching system are very high when compared to the costs of the leaching plant of the present invention.
(iii) The leaching system of the present invention is substantially enclosed, whilst heap leaching systems are exposed to the elements. This causes environmental problems for heap leaching systems such as dust problems, water erosion and leakage of chemicals into the environment.
(iv) Whilst heap leaching systems cost around $2 less per tonne than the leaching system of the present invention, this is more than compensated for by the extra yield (typically more than 15% extra).
(v) Heap leaching has many problems, including “rivering” of liquid solvent through the heap, crystallisation, “gluing”, evaporation and inconsistent ore grade across the heap. Most of these problems are caused by a very slow rate of flow of solvent through the heap—typically 50 hours to travel through a heap the distance of 10 metres. The leaching system of the present invention uses a significantly faster flow rate, around 10 mm per second,
(vi) It is considered that the Trench Leaching System could be used to economically reprocess failed heap leach installations to recover their valuable minerals.
(vii) The Trench Leaching System also has much shorter residency times and higher yields than vat leaching systems.
(viii) Vat leaching systems are plagued by the same “rivering” problems that affect heap leaching.
(ix) In summary, the Trench Leaching System is expected to have a competitive profit advantage over all three prior art systems.
(x) The Trench Leaching System relies upon upward flow of liquid solvent in channels that move randomly through the charge of ore to ensure maximum leaching—which in the test results was around 91% (which is as good as conventional tank leaching for the same ore sample).
(xi) The ore particles within the channels are subject to agitation without the need for agitators, which maximizes the mineral extraction rate whilst minimizing the required energy input.
(xii) The process of the present invention may be conducted in a batch process, but without the passivity associated with conventional vat leaching.
(xiii) For a reasonable time input of less than about six days, minerals can be extracted at industry standard concentrations, with considerable energy and cost-savings. Also, through a dramatic reduction in the use of cyanide, these costs-savings are associated with considerable environmental benefits.

It will be readily apparent to persons skilled in the relevant arts that various modifications and improvements may be made to the foregoing embodiments, in addition to those already described, without departing from the basic inventive concepts of the present invention. For example, the ore may be crushed and/or ground to smaller particle sizes. Also, larger particle sizes could be used, depending upon the ability of the liquid solvent to contact the bound minerals. Further, the tank 40 could be emptied by using a slurry pump positioned within the sump 70, thereby omitting the need for plumbing to be installed from the sump 70 to the waste circuit 18. Still further, the tank 40 could be dimensioned other than as described herein above, such as, for example, it could be longer and narrower and/or wider. Still further, a battery of the tanks 40 could be used to increase the amount of ore processed per annum. Still further, it is to be understood that in the leaching of some ores, the liquid solvent may not be recoverable. Still further, the depth of the charge of ore 50 could be greater than 2.5 m, provided upward channelling of liquid solvent is not prevented from occurring. Still further, the walls 62 to 68 could be made from earthen embankments. In such a case, the orientation of the walls 62 to 68 would be less vertical than for concrete walls and could be provided with sparging tubes. Still further, the system of the present invention could be used in the remediation of toxic tailings dumps. Still further, bacterial leaching programs could be conducted in the system of the present invention. Still further, stripping of the valuable minerals from the pregnant leachate could be by many different forms of subsequent stages of recovery of the valuable minerals. Still further, carbon stripping could be replaced with resin stripping, for example. Therefore, it will be appreciated that the scope of the invention is not limited to the specific embodiments described.

1. A liquid injecting means for a leaching system for extracting valuable minerals from a charge of particularised ore by the use of a liquid solvent, the liquid injecting means including an arrangement of liquid carrying pathways locatable below the charge of ore, and a plurality of downwardly facing apertures distributed about the pathways for producing a plurality of channels of upwardly flowing liquid solvent through the charge of ore, the channels following random paths that vary with time through the charge of ore, wherein particles of ore in the channels are agitated by the liquid solvent, the remaining particles of ore being substantially static and wherein the liquid carrying pathways are devoid of upwardly facing apertures and delivering the liquid solvent at a rate and pressure below that required to cause stratification of the charge of ore.

2. A trench leaching system for extracting valuable minerals from particularised ore, the system comprising:
a delivery means for delivering a charge of the particularised ore;
a tank capable of receiving and retaining the charge of particularised ore for leaching with a liquid solvent;
a liquid injecting means located beneath the charge of ore in the tank for producing a plurality of channels of upwardly flowing liquid solvent through the charge of ore, the liquid injecting means being operated at a flow rate and pressure less than is required to cause fluidisation of the charge of ore, the channels following random paths that vary with time through the charge of ore, and wherein particles of ore in the channels are agitated by the liquid solvent, the remaining particles of ore being substantially static;
a liquid recirculation means for collecting the liquid solvent from on top of the charge of ore and returning it to the injecting means; and,
a liquid collecting means for collecting at least some of the liquid solvent for stripping out dissolved minerals.

3. A trench leaching system according to claim 2, in which the liquid injecting means is in the form of an array of pipes including a plurality of branch lines supplied by main lines, each of the pipes having a plurality of holes provided therein for injecting the liquid solvent into the charge of ore, said holes in the pipes being arranged in a non-upwardly facing direction.

4. A trench leaching system according to claim 3, in which the said holes in the pipes are disposed in a downwardly facing direction at an angle exceeding about 45 degrees to the horizontal.

5. A trench leaching system according to claim 3, also including a pumping system for pumping liquid solvent through the holes in the array of pipes, the pump being adapted to deliver sufficient flow and pressure of the liquid solvent to create a flow rate of between 1 to 5 cm/s of liquid solvent through the charge of ore via the holes, to maintain agitation of ore particles in the channels whilst keeping the remainder of the ore static, so as to avoid total fluidisation of the ore.

6. A trench leaching system according to claim 3, in which the liquid collection means is disposed to collect liquid from, a layer of liquid solvent on top of the charge of ore.

7. A trench leaching system according to claim 6, in which the liquid collection means is in the form of a liquid solvent overflow gutter located below an upper edge of the tank, an upper surface of the gutter being at the level of the liquid solvent in the tank, and a base of the gutter sloping downwardly for carrying the liquid solvent for stripping out the dissolved minerals.

8. A trench leaching system according to claim 6, in which the liquid collection means is in the form of a floating skimmer capable of collecting the liquid solvent from on top of the charge of ore and delivering same for stripping out the dissolved minerals.

9. A trench leaching system according to claim 6, also including a gas injection means for injecting gas into the charge of ore for maintaining the concentration of dissolved gas at a level sufficient to facilitate a mineral extraction process.

10. A trench leaching system according to claim 9, in which the gas injection means injects gas into the liquid solvent above the charge of ore.

11. A process for extraction of valuable minerals from a charge of particularised ore, the process including the steps of:
locating a liquid injection means below the charge of ore;
maintaining the charge of ore substantially static above the liquid injection means; and,
injecting liquid solvent upwardly through the charge of ore at a rate and pressure capable of producing a plurality of channels flowing upwards through the charge of ore, the channels following random paths that vary with time through the charge of ore, wherein particles of ore in the channels are agitated by the liquid solvent and wherein particles of ore outside the channels are maintained substantially static and in contact with the liquid solvent.

12. A process for extraction of valuable minerals from particularised ore, the process including the steps of:
introducing a charge of particularised ore into a tank;
maintaining the charge of ore substantially static in the tank; and,
injecting liquid solvent upwardly through the charge of ore at a rate and pressure capable of producing a plurality of channels flowing upwards through the charge of ore, the rate and pressure being less than required to cause stratification of the said ore, and the channels following random paths that vary with time through the charge of ore, wherein particles of ore in the channels are agitated by the liquid solvent and wherein particles of ore outside the channels are maintained substantially static and in contact with the liquid solvent;
recirculating the liquid solvent by draining some of the liquid solvent from on top of the charge of ore and returning it beneath the charge of ore to be pumped upwardly again through the charge of ore; and,
collecting some of the liquid solvent for stripping out dissolved minerals.

13. A process according to claim 12, in which said step of injecting liquid solvent through the charge of ore comprises pumping liquid solvent through the particularised ore at a sufficient flow and pressure to create a flow rate of between 1 to 5 cm/s of liquid solvent through the charge of ore, to maintain agitation of ore particles in the channels whilst keeping the remainder of the ore static, so as to avoid total fluidisation of the ore.

14. A process according to claim 12, also including the further step of removing fines entrained in the liquid solvent and returning the liquid to an upper region of the tank.

15. A process according to claim 14, also including the step of removing ultrafine particles from the liquid solvent after it is collected for stripping out dissolved minerals.
